(19) United States
(12) Patent Application Publication
(10) Pub. No.: US 2022/0402795 A1
(43) Pub. Date: Dec. 22, 2022

(54) SYSTEMS AND METHODS FOR HYDROPONIC CULTURE WITHOUT PESTICIDES TO REPRESS WATER BORN PATHOGEN

(71) Applicant: LBM AGTECH, Repentigny (CA)

(72) Inventors: Julien LOISEAU, Sainte-Marthe-sur-le-Lac (CA); Richard GIUNTA, Laval (CA); Julien Laprise, Sainte-Julie (CA)

(21) Appl. No.: 17/763,696

(22) PCT Filed: Sep. 25, 2020
(86) PCT No.: PCT/IB2020/059019

§ 371 Date: Mar. 25, 2022

Related U.S. Application Data
(60) Provisional application No. 62/906,788, filed on Sep. 27, 2019.

(51) Int. Cl. C02F 9/00; C05D 9/02; C05G 5/23; C05G 1/00; A01N 59/16; A01N 59/00; A01P 1/00

(52) U.S. Cl. CPC C02F 9/00; C05D 9/02; C05G 5/23; C05G 1/00; A01N 59/16; A01N 59/00; A01P 1/00; C02F 1/4606

(57) ABSTRACT

There is disclosed a water treatment system, a method of water treatment, and a fertilizer for use with the water treatment system and the method of water treatment. The water treatment system for hydroponic culture without pesticides comprises: an ionization device for the ionization of a culture water, the ionization device having at least one electrode for the release of divalent copper cations; a plant tray for the culture of plants; and a plurality of pipes fluidically connected to the ionization device and the plant tray, the culture water being in circulation through the water treatment system.

### FIELD

The present invention generally relates to systems and methods for hydroponic culture, and more particularly to systems and methods for hydroponic culture without pesticides.

### BACKGROUND

A global switch to a plant-based diet coupled with the development of new food production technologies, such as hydroponic culture, offers great promises in feeding an ever-increasing population worldwide, while rendering possible the sustainable development of the planet.

In this regard, hydroponic culture represents a viable and sustainable alternative to traditional agriculture. As such, hydroponic culture needs less nutrients and water (e.g. water may be recirculated) because it requires no soil, enables cultivating plants all year long, has a small land footprint compared to traditional farming, and enables a better control of pathogens as well as a more rigorous control and optimization of the culture conditions.

However, hydroponic culture generally relies on the use of pesticides and other chemical agents to control pathogens and has traditionally been developed for the cultivation of plants in rather large greenhouses. For example, pesticides and other chemical agents may be used to control pathogens like bacteria, fungus, and virus. One type of bacteria commonly found in hydroponic culture setting are bacteria capable of forming polysaccharide-based biofilms of the roots of plants, thereby altering or reducing nutrient exchange and/or absorption by the plants' roots. Alternative to the use of pesticides and other chemical agents acting against pathogens have been developed and used with hydroponic culture. However, these alternatives may not provide effective anti-pathogenic effects against various pathogens and are not necessarily well-adapted for implementation into space-restricted area, such as container(s).

Therefore, there is a need for more effective systems and methods for hydroponic culture without pesticides. There is also a need for such systems and methods that may be implemented and carried out, respectively, in space-restricted area, such as in container(s).

The present invention addresses these needs as well as other needs as it will be apparent from review of the instant disclosure hereinafter.

### SUMMARY

According to an aspect, there is disclosed a water treatment system for hydroponic culture without pesticides, comprising:
an ionization device for the ionization of a culture in water, the ionization device having at least one electrode for the release of divalent copper cations;
a plant tray for the culture of plants; and
a plurality of pipes fluidically connected to the ionization device and the plant tray, the culture water being in circulation through the water treatment system.

In an embodiment, the water treatment system further comprises an ozonation device for generating ozone and fluidically connected to the water treatment system.

In an embodiment, the water treatment system further comprises a filtration device for the removal of solid particles from the culture water.

In an embodiment, the electrode of the water treatment system also releases silver cations.

In an embodiment, the solid particles comprise plant debris and/or pathogens debris.

According to another aspect, there is disclosed a method of water treatment for hydroponic culture without pesticides, comprising a step of ionizing a culture water using at least one electrode that releases divalent copper cations.

In an embodiment, the method of water treatment further comprises a step of fertilizing with a fertilizer low in copper concentration.

In an embodiment, the method of water treatment further comprises a step of providing ozone to the culture water.

In an embodiment, the method of water treatment furthers a step of filtrating solid particles.

According to still another aspect, there is disclosed a fertilizer for hydroponic culture, comprising the following final concentrations of chemical elements:
Nitrogen (N): 125-270 ppm;
Phosphorus (P): 15-90 ppm;
Potassium (K): 85-325 ppm;
Calcium (Ca): 80-265 ppm;
Magnesium (Mg): 0.15-100 ppm;
Sulfate (SO₄): 0-500 ppm;
Chlorine (Cl): 0-500 ppm;
Ammonium (NH₄): 0-36 ppm;
Iron (Fe): 0-20 ppm;
Manganese (Mn): 0-28 ppm;
Zinc (Zn): 0-2 ppm;
Copper (Cu): 0-1 ppm;
Boron (B): 0-1 ppm; and
Molybdenum (Mo): 0-1 ppm.

In an embodiment, the fertilizer is used with the water treatment system as described herein for hydroponic culture without pesticides.

In an embodiment, the fertilizer is used with the method of water treatment as described herein for hydroponic culture without pesticides.

### Definitions

The terms “hydroponic culture” is intended herein to mean a method of growing or culturing plants without soil (i.e. soilless culture) by instead relying on fertilizer solutions (e.g. mineral, oligo-element nutrients, and/or any liquid fertilizers from organic substance(s)) in a water solvent or other liquid growth medium(s) that contains the main source of fertilizers. As intended herein, the terms “hydroponic culture” encompass the use or not of inert medium support such as perlite, gravel, rockwool, clay pellets, foam, recycled foam, peat, sawdust, coconut fibers, and/or the like. Plants may be grown with only their roots exposed to the nutritious liquid, or the roots may be physically supported by the inert medium support. The nutrients used in hydroponic systems may come from an array of different sources, which generally may be in a liquid form, including but not limited to chemical fertilizers or natural source such as water from fish culture and the like.

The term “filtration” is intended herein to mean the process or action in which solid particles in a fluid (i.e. liquids or gases) are removed by the use of a substrate or filter medium that permits the fluid to pass through but retains the solid particles. Either the clarified fluid or the solid particles removed from the fluid may be the desired product. Filtration may be any of various mechanical, physical or biological operations that separates solids from fluids by adding a medium through which only the fluid can pass. The fluid that passes through is called the filtrate. In physical filters oversize solids in the fluid are retained and in biological filters particulates are trapped and ingested and metabolites are retained and removed.

The term “ionization” is intended herein to mean the loss or gain of an electron from an atomic or molecular species. Particularly, ionization is the process or action by which an atom or a molecule acquires a negative or positive charge by gaining or losing electrons, often in conjunction with other chemical changes. The resulting electrically charged atom or molecule is called an ion, which may be an anion or a cation. Ionization can result from the loss of an electron after collisions with subatomic particles, collisions with other atoms, molecules and ions, or through the interaction with electromagnetic radiation. Heterolytic bond cleavage and heterolytic substitution reactions can result in the formation of ion pairs. Ionization can occur through radioactive decay by the internal conversion process, in which an excited nucleus transfers its energy to one of the inner-shell electrons causing it to be ejected.

The term “ozonation” (also referred to as ozonisation) is intended herein to mean the process or action by which ozone (O₃) is infused into water and used as a chemical water treatment. As such, ozone is a powerful oxidant and a very reactive oxygen species able to attack a wide range of organic compounds and also microorganisms. Ozone is produced with the use of energy by subjecting oxygen (O₂) to high electric voltage or to UV radiation, for example. The treatment of water with ozone has a wide range of applications, as it is efficient for disinfection as well as for the degradation of organic and inorganic pollutants.

Features and advantages of the subject-matter hereof will become more apparent in light of the following detailed description of selected embodiments, as illustrated in the accompanying Figures. As it will be realized, the subject-matter disclosed and claimed is capable of modifications in various respects, all without departing from the scope of the claims. Accordingly, the figures and the description are to be regarded as illustrative in nature and not as restrictive; the full scope of the subject-matter is set forth in the claims.

### BRIEF DESCRIPTION OF THE FIGURES

Further features and advantages of the present disclosure will become apparent from the following detailed description, taken in combination with the appended figures, in which:

FIG. 1 illustrates a schematic representation of the water treatment system comprising an ionization device and a plant tray.

FIG. 2 illustrates a schematic representation of the water treatment system comprising an ionization device, a plant tray, and a water culture basin.

FIG. 3 illustrates a schematic representation of the water treatment system comprising an ionization device, a plant tray, a water culture basin, and a fertilizer basin.

FIG. 4 illustrates a schematic representation of the water treatment system comprising an ionization device, a plant tray, a water culture basin, a fertilizer basin, a venturi, and an ozonation device.

FIG. 5 illustrates a schematic representation of the water treatment system comprising an ionization device, a plant tray, a water culture basin, a fertilizer basin, a venturi, an ozonation device, valves, and filters.

FIG. 6 is a bar graph illustrating the comparative anti-pathogenic effects of the water treatment system 500 on reducing the levels of pathogens on culture water initially containing pathogens.

FIG. 7 is a bar graph illustrating the comparative anti-pathogenic effects of the water treatment system 500 on the average plant roots growth in culture water initially containing pathogens.

### DETAILED DESCRIPTION

The present invention relates to a water treatment system and a method thereof for hydroponic culture without pesticides. The present invention also relates to a use with the water treatment system of a fertilizer contained in a culture water for hydroponic culture without pesticides.

The water treatment system provides anti-pathogenic effects for the cultivation of plants and prevents, reduces or eliminates pathogens, including biofilm-forming pathogens, bacteria, fungus, and virus, in a wide variety of plants, including but not limited to lettuce, cucumber, bell pepper, tomatoes, strawberries, herbs, arugula, mustard, kale, tatsoi, parsley, coriander, mint, lemongrass, basilic, ginseng, dill, and the like.

### 1. System Water Treatment

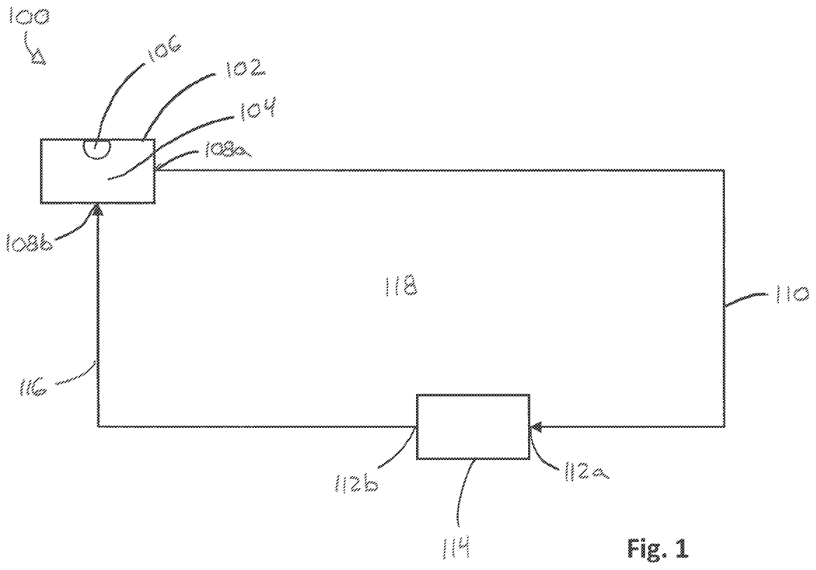

FIG. 1 illustrates an embodiment of a water treatment system 100 that comprises an ionization device 102 and a plant tray 114. The ionization device 102 has an ionization chamber 104 enclosing at least one electrode 106 that is adapted to ionize chemical elements and/or molecules present in the culture water. The ionization device 102 has a first ionization end 108a and a second ionization end 104b, each in fluid communication with the ionization chamber 104. The first ionization end 108a is fluidically connected with a first pipe 110 to a first tray end 112a of the plant tray 114. A second tray end 112b of the plant tray 114 is fluidically connected with a second pipe 116 to the first ionization end 108b of the ionization device 102. In this configuration, a first circulation loop 118 is formed in which the culture water coming from the plant tray 114 is circulated toward the ionization device 102, which ionize the culture water, and the ionized culture water is circulated back toward the plant tray 114. The culture water may or not comprise fertilizer, and the fertilizer may or not comprise a copper-containing component, such as copper sulfate.

In an embodiment, the electrode 106 is adapted to ionize at least one component of a fertilizer present in the culture water. Also, the electrode 106 is made of at least one of the following material: between about 95% (w/w) to about 99.9% (w/w) copper and between about 5.000% (w/w) to about 0.001% (w/w) silver.

In an embodiment, the plant tray 114 may be of the nutrient film technique (NFT) type, in another embodiment the plant tray may be of the deep-water tray type, in still another embodiment the plant tray may be of a hybrid type between the NFT and deep-water types. Alternatively, the plant tray 114 may be of the aeroponic type and/or of the deep-water type.

In an embodiment, the plant tray 114 may have a plant density for plant cultivation ranging from about 12 plant/m² to about 672 plant/m² depending on the cultivated crop.

In an embodiment, the plant tray 114 may comprise a plurality of modular plant trays fluidically connected to one another so as to form a culture pool.

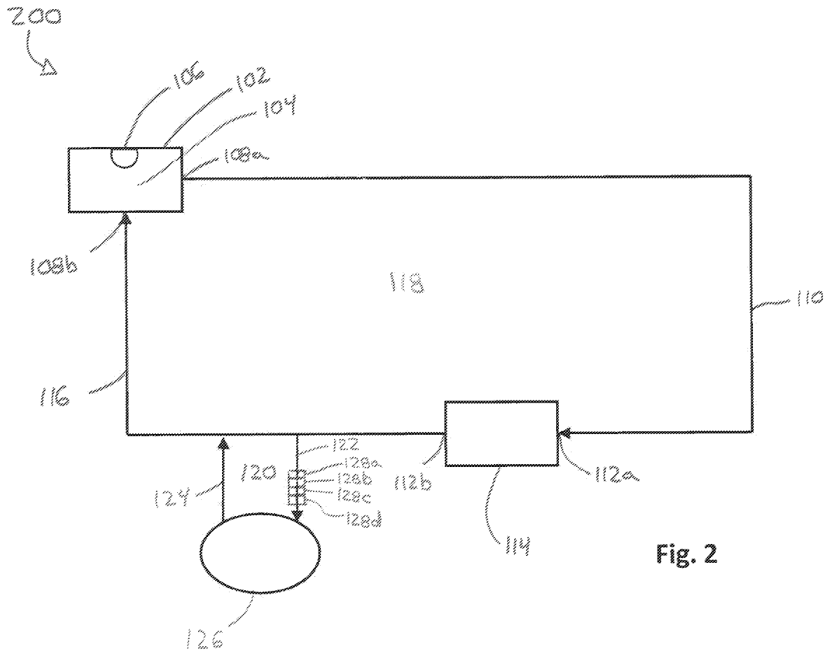

FIG. 2 illustrates an embodiment of a water treatment system 200 that comprises the ionization device 102, the plant tray 114, and a water culture basin 126. The water treatment system 200 further comprises a second circulation loop 120. Third and fourth pipes 122 and 124 each are fluidically connected between the second pipe 116 and the culture water basin 114. The third pipe 122 circulates the water culture coming from the second pipe toward the culture water basin 126, while the fourth pipe 124 circulates the culture water from the culture water basin 126 back toward the second pipe 116. Hence, the second circulation loop 120 is in fluid communication with the first circulation loop 118. The second circulation loop 120 serves to circulate the culture water between the culture water basin 126 and the second pipe 116 of the first circulation loop 118.

In an embodiment, the second circulation loop 120 comprises a copper-reporting probe 128a, an electrical conductivity probe 128b, a pH probe 128c, and a temperature probe 128d, each located on the third pipe 122 and each in fluidic communication between the culture water basin 126 and the second pipe 116 of the first circulation loop 118. The copper-reporting probe 128a, electrical conductivity probe 128b, pH probe 128c, and temperature probe 128d each enable to monitor corresponding parameters of the culture water so as to adjust theses parameters to be optimal for the cultivation of plants. Recommended to conduct copper analyses on a regular base.

In an embodiment, a copper-reporting probe 128a enables to measure and report the level of divalent copper cations present in the water of the water treatment system 200. The skilled addressee will appreciate that any copper-reporting probe may be use, including manually testing for the concentration of copper in the culture water.

In an embodiment, the electrical conductivity probe 128a provides monitoring values which are representative of the conductivity levels of the culture water and thus representative of the electrically conductive species presents in the culture water. Since the electrically conductive species comprise the components of the fertilizer, the electrical conductivity probe 128a is representative of the components of the fertilizer present in the culture water.

In an embodiment, the pH values of the culture water are between about 5.2 to about 7.4, between about 5.5 to about 7.0, between about 5.5 to about 6.3, between about 5.8 to about 6.6, between about 5.8 to about 6.3, or between about 6.1 to about 6.2.

In an embodiment, the temperature of the culture water is between about 14° C. to about 21° C., between about 15° C. to about 20° C., between about 16° C. to about 19° C., between about 17° C. to about 18° C.

In one embodiment, each of the copper-reporting probe 128a, electrical conductivity probe a128b, pH probe 128c, and temperature probe 128d each may be in duplicate, for a total of eight probes. The duplication of probes enables to control or validate the measurement of the first corresponding probe.

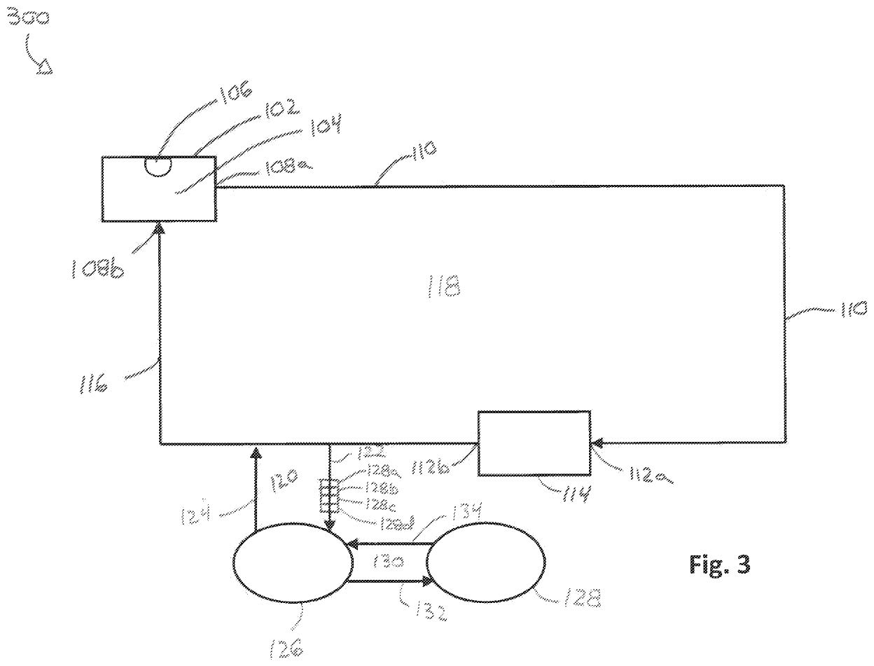

FIG. 3 illustrates an embodiment of a water treatment system 300 that comprises the ionization device 102, the plant tray 114, the water culture basin 126, and at least one fertilizer basin 128. The water treatment system 300 further comprises a third circulation loop 130. The fertilizer basin 128 contains the fertilizer to be added to the water culture basin 126 where the fertilizer is prepared, for example by diluting concentrated fertilizer from the fertilizer basin with the culture water. Sixth and seventh pipes 132 and 134 each are fluidically connected between the culture water basin 126 and the fertilizer basin 128. The sixth pipe 132 circulates the water culture from the culture water basin 126 toward the fertilizer basin 128, while the seventh pipe 134 circulates the culture water from the fertilizer 128 back toward the culture water basin 126. Hence, the third circulation loop 130 is in fluid communication with the second circulation loop 120. Taken together, the first, second, and third circulation loops 118, 120, and 130 are in fluid communication with one another. The third circulation loop 130 serves to circulate the fertilizer from the fertilizer basin 128 to the culture water basin 126.

In an embodiment, the fertilizer basin 128 comprises a plurality of basins, which may be in fluidic communication with the culture water basin 126 for mixing the fertilizer(s) contained in the plurality of basin in the culture water basin 126.

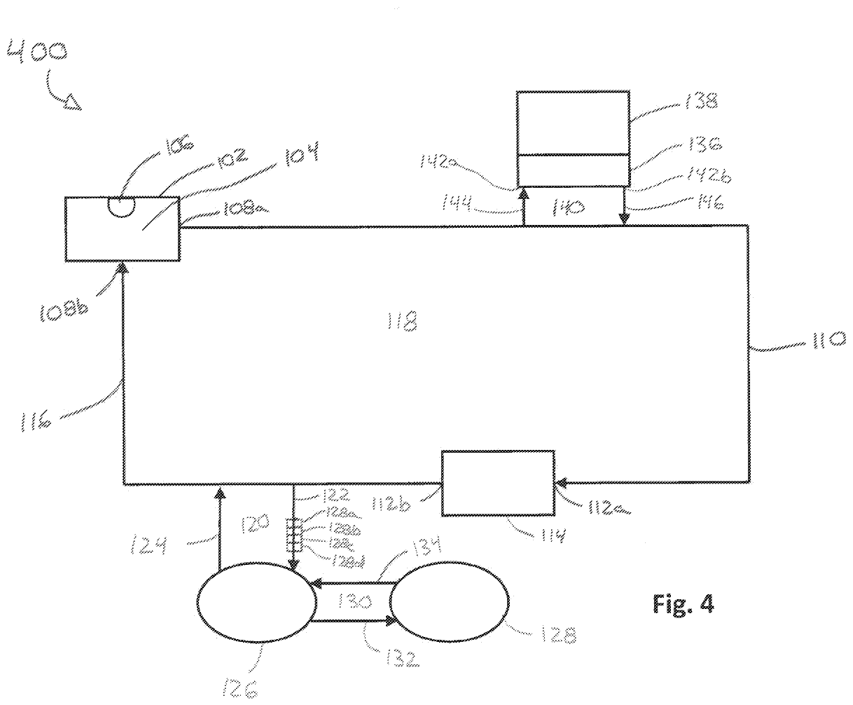

FIG. 4 illustrates an embodiment of a water treatment system 400 that comprises the ionization device 102, the plant tray 114, the water culture basin 126, the fertilizer basin 128, a venturi 136, and an ozonation device 138. The water treatment system 400 further comprises a fourth circulation loop 140. The ozonation device 138 operates cooperatively with the ionization device 102 to improve the anti-pathogenic effects of the water treatment system 400.

As such, the ozonation device 136 is fluidically connected to the water treatment system 400 by a venturi 136, or any other ozone-injecting device, which intake the ozone generated by the ozonation device 138 and introduce or inject the ozone into the culture water. Particularly, the venturi 136 is located on the first pipe 110 and is fluidically connected between the ionization device 102 and the plant tray 114. The venturi 136 has first and second venturi ends 142a and 142b. The first venturi end 142a is fluidically connected to the first pipe 110 by an eight pipe 144 which input the culture water to the venturi 136. The second venturi end 142b is fluidically connected to the first pipe 110 by a ninth pipe 146 which output the ozonated culture water back to the first pipe 110 and the first circulation loop 118. In this configuration, the fourth circulation loop 140 is formed in which the ionized culture water coming from the ionization device 102 may be by-passed toward the venturi 136 for the culture water to be receive ozone, as it will become apparent hereinafter.

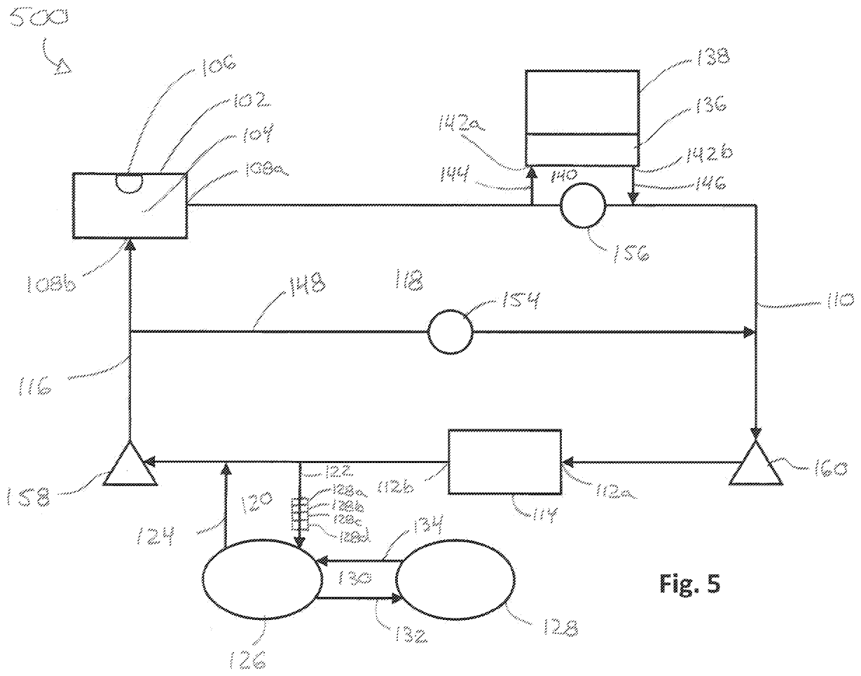

FIG. 5 illustrates an embodiment of a water treatment system 500 that comprises the ionization device 102, the plant tray 114, the water culture basin 126, the fertilizer basin 128, the venturi 136, the ozonation device 138, a seventh pipe 148, first and second filters 150 and 152, as well as first and second valves 154 and 156.

The seventh pipe 148 fluidically connected between the first pipe 116, i.e. between the fourth pipe 124 and the ionization device 102, and the second pipe 110, i.e. between the venturi 136 and the plant tray 114. As it will become apparent herein after, the seventh pipe 148 serves with the first valve 154 to by-pass parts of the first and second pipes 110 and 116, including the ionization device 102, the venturi 136, and the ozonation device 138, when the culture water is not required to have ionization and/or ozonation treatment in order to have anti-pathogenic effects on the cultivation of plant.

The first valve 154 is located on the seventh pipe 148 and is fluidically connected between the second pipe 116 and the first pipe 110. The first valve 154 may regulate the flow of the culture water along the seventh pipe 148 so as to also regulate the flow of the culture water thought part of the first and second pipes 110 and 116, including the ionization device 102 as well as the venturi 136 and the ozonation device 138. When completely closed, the first valve 154 may completely redirect the flow of culture water thought the ionization device 102 as well as the venturi 136 and the ozonation device 138. When open, the first valve 154 may partially or substantially by-pass the culture water from the first and second pipes 110 and 116, including the ionization device 102 as well as the venturi 136 and the ozonation device 138.

The second valve 156 is located on the first pipe 110 and is fluidically connected between the eighth and ninth pipes 144 and 146. When completely closed, the second valve 156 may completely redirect the flow of culture water thought the venturi 136 where ozone generated by the ozonation device 138 is introduced or injected into the culture water. When open, the second valve 156 may partially or substantially by-pass the culture water from the venturi 136 and ozonation device 138.

In an embodiment, the first and second valves 154 and 156 are ball valve or any other valves known in the art.

The skilled addressee will appreciate that the water treatment systems described herein may comprises other valve(s) located on any pipes and/or basin thereof.

The first filter 158 may be located on the second pipe 116 and is fluidically connected between the fourth pipe 120 and the ionization device 102. The first filter 158 enables filtration of solid particles, such a debris coming from the plant roots, that may damage the water treatment system 500 if entering thereinto. The first filter 158 also assure optimal performance of the water treatment system 500. For its part, the second filter 160 may be located on the first pipe 110 and fluidically connected between the venturi 136 and the plant tray 114. The second filter 160 separate or remove debris from culture water that may be detrimental to the water treatment system 500.

In an embodiment, the first, second filters 158, 160 may comprise sediment filter, sand filter and/or any other filter devices known in the art.

The skilled addressee will appreciate that the first, second filters 158, 160 may further be adapted to filter smaller solid particles, such as pathogens, biofilms and debris thereof, in order to improve the anti-pathogenic effects of the water treatment system 500. The person skilled in the art will further appreciate that the removal of solid particles improves the anti-pathogenic effects of the water treatment system 500 as reactive chemical species, such as reactive ion species and ozone, may react more directly with the pathogens.

In an embodiment, the water treatment system 500 may further comprise one or more pump(s), a water hardness monitoring and/or control device, as well as an input for inputting fresh water into the water treatment system 500 and an output for outputting the culture water from the water treatment system 500.

In an embodiment, any one of the water treatment systems described herein may be implemented in a space-restricted area, such as container(s). In case where any one of the water treatment system(s) 100, 200, 300, 400, and 500 is implemented into multiple containers, the containers may have various configurations. The space-restricted area, such has one or more container(s), may also be adapted to provide optimal conditions for the hydroponic culture of plants, including temperature condition, humidity condition, ventilation condition, and lighting condition, for example. The container(s) may also be air-tight in order to reduce the risk of pathogens contamination. One or more control systems may also be used to monitor and control the various conditions for optimal hydroponic plant culture.

### 1.1. Ionization Treatment of the Culture Water

Ionization may be used for the treatment of water, for example as a disinfectant process. For general water treatment as for hydroponic water treatment, various ionization technologies are available, one of such rely on the use of an electrode to generate or produce from chemical element(s) and molecule(s) reactive ion species like anions and cations.

Reactive ion species have anti-pathogenic effects by acting upon the pathogens present in water, including bacteria, fungus, and virus, thereby eliminate or substantially inactivating them. For example, bacteria may include Pseudomonas sp., Xanthomonas sp., Agrobacterium sp., Pectobacterium sp., Erwinia sp. Streptomyces scabia, and Ralstonia solanacearum. Fungus may include Rhizpctonia sp., Pythium sp., Colletotrichum sp., Fusarium sp., Embellisia sp., Phytophthora sp., Alternaria sp., Gaeumannomyces sp., Rhexocercosporadium sp., Plasmodiosphore sp., Thielaviopsis basicola, Verticilium dahlia, and Phytophtora fragariae. Virus may include ToRSV, INSV, Potyvirus, CMV, TSMV, MLBVV, and PMTV.

Another example of bacteria that is usually common in hydroponic culture setting are bacteria capable of producing polysaccharide-based biofilms on the roots of the plants. When the culture water of a hydroponic culture is contaminated with such bacteria or fungus, the plants' roots become coated with biofilm(s) which may alter or reduce the exchange of the plants' roots with its environment, notably at the level of the absorption of nutrients from the culture water.

In order to have optimal anti-pathogenic effects against pathogens, the concentrations or levels of the reactive ion species generated by ionization must be controlled precisely. Consequently, the amount of chemical compound(s), such as a fertilizer and components thereof, that generate the reactive ion species upon ionization must also be controlled precisely. While low concentrations or levels of reactive ion species may be ineffective against pathogens, high concentrations or levels of reactive ion species may induce detrimental effects on the cultivated plant.

Particularly, for the water treatment systems describes herein, copper sulfate (CuSO₄) may be used as a component of the fertilizer in order to generate by ionization divalent copper cations (Cu²⁺), a reactive ion species. However, the amount of copper sulfate that must be added to the fertilizer and culture water must just enough to provide appropriate anti-pathogenic effects to the cultivated plant without having detrimental effects on the plants.

Advantageously, it has been found that the water treatment systems described herein may provide anti-pathogenic effects to the cultivated plants in absence of copper sulfate in the fertilizer and culture water. Indeed, the electrode 106 has been found to itself release divalent copper cations during operation into the culture water in an amount sufficient to have anti-pathogenic effects on the cultivated plants without having detrimental effects on the plants. In such case, the electrode is made of copper (about 99% (w/w)) and silver (less than about 1% (w/w)). In fact, it has also been found that the addition of a copper-releasing source, such as copper sulfate, to the fertilizer and culture water generate in combination with the operation of the electrode 106 high concentrations or levels of divalent copper cations that may induce detrimental effects to the cultivated plants. High concentrations or levels of copper in the culture water increase the plant roots decay and induces leaves injuries, which become good host to botrytis infection.

Therefore, the amount of divalent copper cations released from the electrode 106 into the culture water is sufficient to establish a concentration of reactive ion species that have appropriate anti-pathogenic effects on the cultivated plants while not having detrimental effects on same. The level of electrode ionization is adjusted through the voltage input to the cathode (0-24v) and the time duration of the electrical input which can varies due to the water quality from few seconds per weeks to full time).

In an embodiment, the concentration required to have anti-pathogenic effects (i.e. effects against pathogens) of divalent copper cations in the culture water comprises between about 0.01 ppm to about 0.70 ppm.

Similarly, it has been further found that the water treatment systems described herein may further provide anti-pathogenic effects to the cultivated plants. Indeed, the electrode 106 may also release a sufficient amount of divalent silver cations to establish a concentration of reactive ion species that have appropriate anti-pathogenic effects on the cultivated plants while not having detrimental effects on same. As for the release of divalent copper cations, the electrode in such case is made of copper (about 99% (w/w)) and silver (less than about 1% (w/w)).

In an embodiment, the concentration to have anti-pathogenic effects (i.e. effects against pathogens) of divalent silver cations in the culture water comprises between about 0.01 ppm to about 0.10 ppm.

The skilled addressee will appreciate that while divalent cations, such as divalent copper and silver cations, may have anti-pathogenic effects on the cultivation of plants, any other divalent cations, such as group 11 element including gold (Au), might be used by the water treatment systems described herein to provide anti-pathogenic effects without departing from the scope of the present invention.

The skilled addressee will further appreciate that for the electrode 106 to release divalent copper and silver cations into the culture water, the electrode 106 must be cleaned so as to maintain a proper contact surface with the culture water. This is because a built-up of oxidized and/or organic material(s) is formed over time on the surface of the electrode 106, preventing or reducing the contact of the electrode with the culture water and thus ions release. Alternatively, the ensure an appropriate release of divalent copper and silver cations, the electrode 106 may be replaced with a new, unoxidized one instead of cleaning a defective ion-releasing electrode 106.

### 1.2. Ozonation Treatment of the Culture Water

In an embodiment, the ozonation devices chemically transform or convert the dioxygen (O₂) present in the air into ozone (O₃), which is introduced or injected into the culture water of the water treatment system 100, 200, 300, 400, and 500 via the venturi 136. Ozone is a powerful disinfectant and a strong oxidizer that react with pathogens, including biofilm-forming pathogens, bacteria, fungus, and virus, in order to eliminate or substantially inactivate them. For example, ozone may denature polysaccharide biofilms. Since ozone as generally a short period of action, it may be used in cooperation with the reactive ion species generated by the ionization device 102.

The skilled addressee will appreciate that the ozone may be introduced or injected into the culture water by any means know in the art.

In an embodiment, the concentration to have anti-pathogenic effects (i.e. effects against pathogens) of ozone in the culture water comprises between about 0.001 ppm to about 0.500 ppm.

The skilled addressee will appreciate that any other disinfectant agent(s) used for water treatment, such as chlorine, may also be used with any of the reactive ion species and/or ozone without departing from the scope of the present invention.

While the ionization device 102 is located downstream from the ozonation device 138 with respect to the culture water of the in the water treatment systems 400 and 500, the skilled addressee will further appreciate that the ionization device 102 may also be located upstream from the ozonation device 138 with respect to the culture water of the in the water treatment systems 400 and 500 without also departing from the scope of the present invention.

### 1.3 Electrostatic Fluid Conditioner

The electrostatic fluid conditioner is to be put anywhere, but not necessarily in the recircling water loop to increase the efficiency of the ionization on the anti-pathogenic effects.

Advantageously, it has been found that the amount of fertilizer in the water may be drastically decreased depending on the crops cultivated without inducing any deficiency symptom on the crop. For example strawberries were successfully cultivated over a year with an Ec between 1 and 1.25 with weekly harvest.

### 2. Method of Water Treatment

Another aspect of the present invention relates to a method of water treatment producing a culture water capable of sustaining the cultivation of plants, such as in hydroponic culture, without pesticide(s) and/or other chemical agent(s) acting against pathogens.

In an embodiment, the culture water may be produced by ionizing chemical elements and/or molecules that are present in the culture water to generate reactive ion species (anions and cations) which have anti-pathogenic effects and eliminate or substantially inactivate the pathogens (bacteria, fungus, and virus). The chemical elements and/or molecules may be provided to the culture water as fertilizer.

In an embodiment, the culture water may also be produced by introducing or injecting ozone into the culture water. In this case, the ozone cooperates with the reactive ion species to provide the anti-pathogenic effects associated with the culture water.

In an embodiment, the step of ionization is before the step of ozonation. In another embodiment, the step of ionization is after the step of ozonation.

In an embodiment, the culture water may also be produced by filtrating the culture water to remove solid particles. Such solid particles may be plant debris and/or pathogen debris.

In an embodiment, the culture water may selectively be in recirculation. Still in this embodiment, the culture water may be treated continuously or treated periodically according to a predefined schedule.

### 3. Fertilizers

Another aspect of the present invention also relates to a use of a fertilizer with the water treatment systems described herein to enable hydroponic culture without pesticides. As such, the fertilizers may comprise at least two functions: (i) to provide nutrients to sustain plant growth (as it is commonly accepted for fertilizers), and (ii) to serve as reagent for the generation of reactive ion species by the ionization device 102 of the water treatment systems described herein.

In an embodiment, the fertilizer used with the method of water treatment comprises the following final concentrations of chemical elements:
Nitrogen (N): 125-270 ppm;
Phosphorus (P): 15-90 ppm;
Potassium (K): 85-325 ppm;
Calcium (Ca): 80-265 ppm;
Magnesium (Mg): 0.15-100 ppm;
Sulfate (SO₄): 0-500 ppm;
Chlorine (Cl): 0-500 ppm;
Ammonium (NH₄): 0-36 ppm;
Iron (Fe): 0-20 ppm;
Manganese (Mn): 0-28 ppm;
Zinc (Zn): 0-2 ppm;
Copper (Cu): 0-1 ppm;
Boron (B): 0-1 ppm; and
Molybdenum (Mo): 0-1 ppm.

In an embodiment, the concentrations of the chemical elements may be varied by a factor of 50%, 75%, and 100% to accommodate inter-species variabilities of the cultivated plants.

In an embodiment, the components making the fertilizer used with the method of water treatment comprise the following chemicals:
Nitrate de calcium (18% (w/w) Calcium (Ca) content);
Nitrate de calcium (19% (w/w) Calcium (Ca) content and 1% (w/w) ammonium (NH₄) content);
Nitrate de potassium Haifa (13% (w/w) nitrate (NO₃) content, 9% (w/w) phosphorus (P) content, and 17% (w/w) ammonium (NH₄) content);
Ammonium nitrate (17% (w/w) nitrate (NO₃) content and 17% (w/w) ammonium (NH₄) content);
Calcium chloride (27% (w/w) calcium (Ca) content and 49% (w/w) chlorine (Cl) content);
Monopotassium phosphate (23% (w/w) phosphorus (P) content and 29% (w/w) potassium (K) content);
Phosphoric acid (27% (w/w) phosphorus (P) content);
Magnesium sulfate (9.8% (w/w) magnesium (Mg) content and 13% (w/w) sulfur (S) content);
Potassium sulfate (43.3% (w/w) potassium (P) content and 18% (w/w) sulfur (S) content, and 45% (w/w) sulfate (SO₄));
Potassium chloride (52% (w/w) phosphorus (P) content and 46% (w/w) chlorine (Cl) content);
Pekacid (26.2% (w/w) phosphorus (P) content and 16.6% (w/w) potassium (K) content);
Chelated Iron (13% (w/w) pentetic acid);
Manganese sulfate (31.5% (w/w) manganese (Mn));
Zinc sulfate (36% (w/w) zinc (Zn));
Borax (15% (w/w) boron (B)); and
Sodium Molybdate (46% (w/w) molybdate (Mb)).

In an embodiment, the fertilizer is used with the water treatment systems described herein in order to provide anti-pathogenic effects to the cultivated plants.

In an embodiment, the fertilizer is used with the water treatment systems described herein in order to provide anti-pathogenic effects to the plants grown by hydroponic culture.

In an embodiment, the fertilizer is free of copper or with a low copper element concentration, such as a copper-containing component that would be otherwise added to or present in the fertilizer, and the fertilizer is used with the water treatment systems described herein in order to provide anti-pathogenic effects to the cultivated plants, for example plants grown in hydroponic culture.

In an embodiment, the fertilizer comprises a first mixing solution and a second mixing solution to be mixed together before use in order to make the fertilizer and avoid precipitation of component(s) thereof.

In an embodiment, the pH of the culture water and/or of the water containing the fertilizer may be adjusted with any one of phosphoric acid, citric acid, nitic acid, and a combination thereof.

While preferred embodiments have been described above and illustrated in the accompanying figures, it will be evident to the skilled addressee that modifications may be made without departing from this disclosure. Such modifications are considered as possible variants comprised in the scope of the disclosure.

The present invention will be more readily understood by referring to the following examples which are given to illustrate the invention rather than to limit its scope.

The following example(s) disclose trials and experiments using the water treatment systems described herein and the method of water treatment described herein.

### Example 1

### Comparative Anti-Pathogenic Effects of the Water Treatment System 500 on Reducing the Levels of Pathogens on Culture Water Initially Containing Pathogens

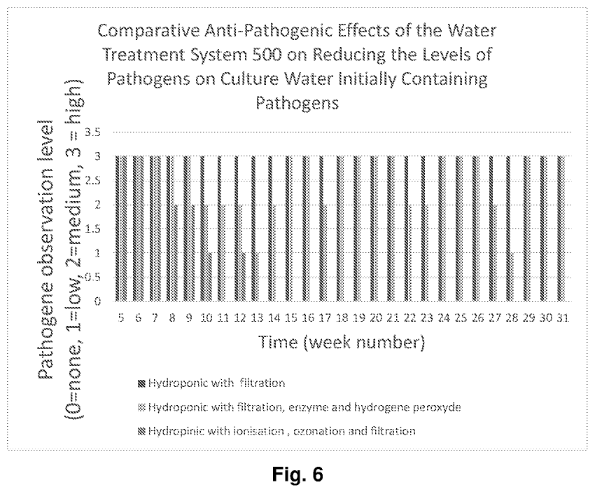

FIG. 6 illustrates a comparison of the anti-pathogenic effects over time of the water treatment system 500 with a system involving only filtration and another system involving a filtration, an enzymatic activity, and hydrogen peroxide (H₂O₂). As shown, the water treatment system 500 is able to gradually reduce the concentrations or levels of the pathogens initially present (i.e. from 3 to o over t=5-31) in the culture water being treated by the water treatment system 500 to an undetectable concentration or level (i.e. zero (0) at t=13) and is also able to maintain an undetectable concentration or level over time thereafter (i.e. zero (0) over t=13 to 31).

In comparison, the system involving only filtration is unable to reduce the concentrations or levels of the pathogens initially present in the culture water (i.e. 3 over t=5 to 31). On the other hand, the system involving a filtration, an enzymatic activity, and hydrogen peroxide is able to partially reduce the concentrations or levels of the pathogens initially present in the culture water, and the reduction is not maintained over time (i.e. varying between 3 and 1 over t=5 to 31).

Therefore, the comparative results illustrated in FIG. 6 are indicative of the anti-pathogenic effects of at least one of reactive ions species, such as divalent copper cations, and ozone from the water treatment system 500 in reducing the concentrations or levels of the pathogens initially present in the culture water, as compared to the other water treatment systems tested.

### Example 2

### Comparative Anti-Pathogenic Effects of the Water Treatment System 500 on the Average Plant Roots Growth in Culture Water Initially Containing Pathogens

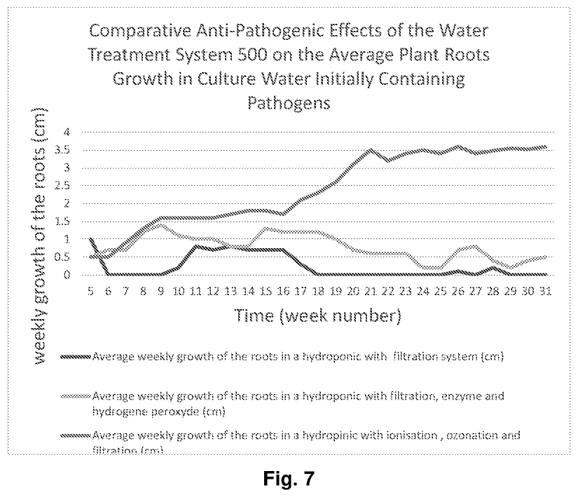

FIG. 7 illustrates another comparison of the anti-pathogenic effects over time of the water treatment system 500 with a system involving only filtration and another system involving a filtration, an enzymatic activity, and hydrogen peroxide (H₂O₂). As shown, the anti-pathogenic effects of the water treatment system 500 is able to sustain the growth of the plant roots (i.e. from 0.5 to 3.5 cm from t=5 to 20) and is also able to maintain the length of the plant roots grown over time (i.e. at 3.5 cm over t=20 to 31).

In comparison, the system involving only filtration is unable to sustain the growth of the plant roots so that the plant roots essentially reduce in length over time (i.e. approx. 0.5 to 0 cm over at t=5 to 31). On the other hand, the system involving a filtration, an enzymatic activity, and hydrogen peroxide is able to marginally increase the plant roots in length for a certain period of time (i.e. to approx. 1.5 cm over t=5 to approx. 20), but the plant roots reduce in length over time thereafter (i.e. from 1.5 to approx. 0.5 cm over t=21 to 31).

Therefore, the comparative results illustrated in FIG. 7 are indicative of the anti-pathogenic effects of at least one of reactive ions species, such as divalent copper cations, and ozone from the water treatment system 500 in sustaining and maintaining plant roots length, as compared to the other water treatment systems tested.

1. A water treatment system for hydroponic culture without pesticides, comprising:
an ionization device for the ionization of a culture water, the ionization device having at least one electrode for the release of divalent copper cations;
a plant tray for the culture of plants; and
a plurality of pipes fluidically connected to the ionization device and the plant tray, the culture water being in circulation through the water treatment system.

2. The water treatment system of claim 1, further comprising:
an ozonation device for generating ozone and fluidically connected to the water treatment system; and/or
an electrostatic fluid conditioner.

3. The water treatment system of claim 1, further comprising:
a filtration device for the removal of solid particles from the culture water.

4. The water treatment system of claim 1, wherein the solid particles comprise plant debris and/or pathogens debris.

5. A method of water treatment for hydroponic culture without pesticides, comprising a step of:
ionizing a culture water using at least one electrode that release divalent copper cations.

6. The method of water treatment of claim 5, further comprising a step of fertilizing with a fertilizer in low copper element concentration.

7. The method of water treatment of claim 5, further comprising a step of providing ozone to the culture water.

8. The method of water treatment according to claim 5, further comprising a step of filtrating solid particles.

9. A fertilizer for hydroponic culture, comprising the following final concentrations of chemical elements:
Nitrogen (N): 125-270 ppm;
Phosphorus (P): 15-90 ppm;
Potassium (K): 85-325 ppm;
Calcium (Ca): 80-265 ppm;
Magnesium (Mg): 0.15-100 ppm;
Sulfate (SO₄): 0-500 ppm;
Chlorine (Cl): 0-500 ppm;
Ammonium (NH₄): 0-36 ppm;
Iron (Fe): 0-20 ppm;
Manganese (Mn): 0-28 ppm;
Zinc (Zn): 0-2 ppm;
Copper (Cu): 0-1 ppm;
Boron (B): 0-1 ppm; and
Molybdenum (Mo): 0-1 ppm.

10. The fertilizer of claim 9, wherein the fertilizer is used with a water treatment system for hydroponic culture without pesticides, comprising:
an ionization device for the ionization of a culture water, the ionization device having at least one electrode for the release of divalent copper cations;
a plant tray for the culture of plants; and
a plurality of pipes fluidically connected to the ionization device and the plant tray, the culture water being in circulation through the water treatment system.

11. The fertilizer of claim 9, wherein the fertilizer is used with a method of water treatment for hydroponic culture without pesticides, comprising a step of:
ionizing a culture water using at least one electrode that release divalent copper cations.
